(19) United States
(12) Patent Application Publication
(10) Pub. No.: US 2015/0058259 A1
(43) Pub. Date: Feb. 26, 2015

(54) METHOD AND SYSTEM OF ENABLING INVESTMENT IN REAL ESTATE ASSETS IN EXCHANGE FOR PERIODIC PAYMENTS

(71) Applicant: Timothy HAUG, Jacksonville, FL (US)

(72) Inventor: Timothy HAUG, Jacksonville, FL (US)

(21) Appl. No.: 14/528,742

(22) Filed: Oct. 30, 2014

Related U.S. Application Data
(63) Continuation of application No. 13/745,302, filed on Jan. 18, 2013, now abandoned.
Application No. 13/745,302 is a continuation of application No. 12/578,328, filed on Oct. 13, 2009, now abandoned.
(60) Provisional application No. 61/104,912, filed on Oct. 13, 2008.

(51) Int. Cl. G06Q 40/06; G06Q 50/16

(52) U.S. Cl. CPC G06Q 40/06; G06Q 50/16
USPC 705/36 R

(57) ABSTRACT

A method and system of enabling an investor to invest in real estate asset in exchange for periodic payments to the owner of the real estate asset includes: a) receiving from the investor criteria for investments in real estate assets, b) obtaining a plurality of applications from the owners of their real estate assets who desire to exchange an interest in potential future appreciation of their respective real estate assets for periodic payments from an investor, each of the applications including information pertaining to the respective owner and to its real estate asset, c) storing the investor criteria and the information pertaining to the owner and its real estate asset, d) reviewing the plurality of applications to determine whether the information in the applications matches the investor criteria, and e) for those of the plurality of applications having information that matches the investor criteria, facilitating each investor to enter into individual contracts with selected ones of the corresponding owners to exchange the periodic payments for an interest in said potential future appreciation of the corresponding real estate assets of selected owners.

### CROSS REFERENCE TO RELATED APPLICATION

This application claims the benefit of priority under 35 U.S.C. §119 to U.S. provisional patent application Ser. No. 61/104,912, filed on Oct. 13, 2008, which is incorporated by reference herein in its entirety, non-provisional patent application Ser. No. 12/578,328 filed Oct. 13, 2009, and Continuation application Ser. No. 13/745,302 filed Jan. 18, 2013 which are incorporated by reference herein in their entireties.

### FIELD OF THE INVENTION

The present invention relates to a method and system for enabling investors to invest in a portion of the capital appreciation in real estate-based assets without having to own the real estate, and for enabling payments to be made directly to home owners or to lending institutions, to provide the home owners with immediate capital for debt service or other productive uses by senior home owners. Investors will be able to customize their investment selection by geography, household income, property type, property utilization, home value maximum, equity sharing, affinity grouping and home owner payment.

### BACKGROUND OF THE INVENTION

The housing financial crisis which became apparent in 2007 in the United States began in large part with sub-prime mortgages for which defaults and threats of defaults became widespread. Rising interest rates have made mortgages increasingly difficult to afford, especially for home owners who received financing with lax and often predatory lending practices. The sub-prime crisis then spread to more traditional mortgages as housing prices began to fall, and has lead to a situation in which many recent home buyers find that they cannot afford the monthly payment on mortgages worth more than their real estate assets are worth. Partly due to the dropping asset values, and also to the resetting of initial ‘teaser’ interest rates on adjustable mortgages, foreclosure rates on more traditional mortgages have rapidly increased, further exacerbating the drop in housing prices. Commentators have noted that the housing crisis will continue until the prices of real estate assets stabilize. In the meantime the U.S. federal government is enacting remedial measures such as the Foreclosure Prevention Act to aid home owners who are trying to avoid foreclosure.

The private sector has been hesitant to invest in real estate assets or in asset-backed financial instruments because of the continuing downward trends, holding back crucial funds that might otherwise be applied toward aiding home owners and stabilizing real estate asset prices. Banks in particular have returned to more disciplined lending practice, reducing a source of liquidity that was widely available to home owners. This has made the dream of home ownership especially challenging for first-time home buyers. Today's credit culture and practices mirror classical lending standards and practices during the 1980s when full documentation, conservative lending guidelines and lack of exceptions were the norm.

Although to date there are a number of financial arrangements in which home owners can obtain funds (as income or a lump sum) in exchange for an equity interest in their real estate assets, they either are too restrictive, such as reverse mortgages which require the owner to be at least 62 years of age, or they are unattractive to the investment community because of the risks involved.

It would therefore be desirable to provide a financial arrangement which will effectively encourage investors to provide funds to home owners in need of ready cash in exchange for an interest in their real estate assets and more particularly in the unrealized and future gains in property values. The investor's ability to customize their investment selection enhances their ability to meet their investment objectives.

### SUMMARY OF THE INVENTION

In a first aspect, the present invention provides a method of enabling an investor to invest in a real estate asset in exchange for periodic payments to the owner of said real estate asset. The method includes: a) receiving from an investor criteria for investments in real estate assets, b) obtaining a plurality of applications from the owners of their real estate assets who desire to exchange an interest in potential future appreciation of their respective real estate assets for periodic payments, each of the applications including information pertaining to the owner and to his or her real estate asset, c) storing the investor criteria and information pertaining to the owner and to his or her real estate asset in a computer system; d) determining, by using the computer system, whether the information in the applications matches the investor criteria, and e) for those of the plurality of applications having information that matches the investor criteria, facilitating the investor to enter into individual contracts with selected ones of the corresponding owners to exchange periodic payments for an interest in the potential future appreciation of the corresponding real estate assets of said selected owners.

In a second aspect, the present invention provides a method of enabling a plurality of investors to invest in individual real estate assets in exchange for periodic payments to the respective owners of said real estate assets, comprising: a) receiving from each of said investor criteria for investments in real estate assets, b) obtaining a plurality of applications from owners of real estate assets who desire to exchange an interest in potential future appreciation of their respective real estate assets for periodic payments, each of said applications including information pertaining to the respective owner and to its real estate asset, c) storing the investor criteria and the information pertaining to the respective owner and to its real estate asset in a computer system, d) determining, by using the computer system, whether the information in said applications matches any of said investor criteria; and e) for those of said applications having information that matches at least one of said investor criteria, facilitating said investor to enter into one or more individual contracts with selected ones of said corresponding owners to exchange periodic payments for an interest in said potential future appreciation of the corresponding real estate asset of the selected owner.

In a third aspect, the present invention provides a system for enabling investors to invest in potential appreciation of real estate assets of others in exchange for periodic payments to the owners of said real estate assets. The system includes a communication interface, a processor, a memory coupled to the processor, and a management module executable by the processor and adapted to: a) store investor criteria for investments in real estate assets in memory, b) store information pertaining to owners and their real estate assets taken from applications from the owners, c) determine whether the information pertaining to the owners and their real estate assets matches the investor criteria, and d) for those owners where said information matches investor criteria, facilitate establishment of individual contracts with selected owners to exchange periodic payments from the investor for an interest in future appreciation of the corresponding real estate assets of the selected owners by informing the owners and the investors via the communication interface. Preferably, the flow of funds from the investor and from any potential appreciation sharing will be paid through a custodian bank which in turn will transfer funds to the home owner or to the mortgage holder, thereby enhancing the program's transparency and fiduciary commitments.

### BRIEF DESCRIPTION OF THE DRAWINGS

FIG. 1A is a block diagram showing a system for enabling investment in real estate assets in exchange for periodic payments to an owner according to an embodiment of the present invention.

FIG. 1B shows the system of FIG. 1A in which real estate assets are arranged according to investor selection criteria.

FIG. 1C shows an exemplary contract formation in the system of FIG. 1A and 1B.

FIG. 1D shows an exemplary payment distribution in the system of FIGS. 1A-C.

FIG. 2 is a flow chart of a method of establishing a contract in which investors make payments to owners of a real estate asset in exchange for potential appreciation in the real estate asset.

FIG. 3 is a flow diagram of a method of service a contract between investors and owners according to an embodiment of the present invention.

FIG. 4A is a block diagram showing a system for enabling investment in real estate assets in exchange for periodic payments to an owner according to another embodiment of the present invention.

FIG. 4B is a block diagram showing a system for enabling investment in real estate assets in exchange for periodic payments to an owner according to another embodiment of the present invention.

FIG. 5 illustrates a system for enabling investors to invest in potential appreciation of real estate assets of others in exchange for periodic payments to the owners of the real estate assets.

### DETAILED DESCRIPTION OF THE PREFERRED EMBODIMENTS

The term ‘owner’ as used herein denotes both a current owner(s) of a real estate asset (either fully paid or subject to a mortgage) and/or a person or other entity who is applying for a mortgage to purchase real estate asset.

The present invention provides a method and system of enabling and managing the investments in real estate assets in which an investor purchases individual contracts. The contracts may be made directly between the investor and an individual owner of the real estate asset, or the contracts may be intermediated, whereby the investor contracts with an intermediary entity to provide funds in exchange for rights in the potential future appreciation of a selection of real estate assets, and the intermediary in turn contracts with individual owners of real estate assets to provide payments in return for rights in the potential future appreciation of those real estate assets. In each case the contract provides that the investor provide a stream of periodic payments to each owner in exchange for rights to a percentage of potential future appreciation in the value of the real estate assets determined upon a termination date, (e.g., sale of the real estate asset, new contract, or the end of a twenty-year term). In preferred embodiments of the invention the real estate assets are residential homes and properties but may also be applied to commercial real estate.

The method and system according to the present invention allows each investor to set the percentage of future appreciation, if any, it will be entitled to receive under the contract. This percentage, in turn, will be applied to the appraised value of the home to determine the “notional amount”. The notional amount multiplied by the payment rate set by the investor determines the payment to the home owner. The payment rates which the investor is willing to exchange for potential future appreciation in real estate assets will reflect its view of the risks and potential return involved. The payment rates may be based, for example, on a desired expected rate of return and/or the characteristics of the real estate assets. Additionally, the defined payment rates of return may include a discount taking into consideration a sense of ‘social responsibility’ the investor has to the public or to a particular association or its membership. Typical investors would include pension funds. The contracts may create soft landings for current owners of subprime or other mortgage types. If adopted by many institutional investors, these contracts could have a palliative effect on the current real estate crisis. Since each owner retains an interest in the appreciation of her or his real estate asset, she or he has an incentive to maintain and improve upon the asset, making the owner a more attractive recipient of investments in the view of both lenders and investors.

By providing payments directly to lenders, the present invention enhances the owners' credit worthiness, and encourages lenders to enter into mortgages or other loans which they might otherwise be reluctant to enter. To further this end the system enables investors to make payments directly to lenders, thus reducing out-of-pocket expenses for the owners. When payments go directly to the lender, the proceeds can be considered a reduction in credit expenses (vs. an increase in income), which may help owners better qualify for loans through lower obligation-to-income (OTI) ratios. In light of current Reverse Mortgage (RM) tax treatment, it is anticipated that payments to the owner under the contract will be tax-deferred until contract settlement. Owners for which this arrangement is not applicable or desirable, for example, seniors who already own their homes free and clear, may receive payments directly from the custodian bank as directed by the manager.

The monetary relief afforded by the investments according to the present invention may supplement government and community programs to help the disadvantaged and stabilize the housing market and will complement the recent bipartisan federal housing bill by enabling participation by significantly more than the 500,000 foreclosure-threatened owners that the legislation is projected to help.

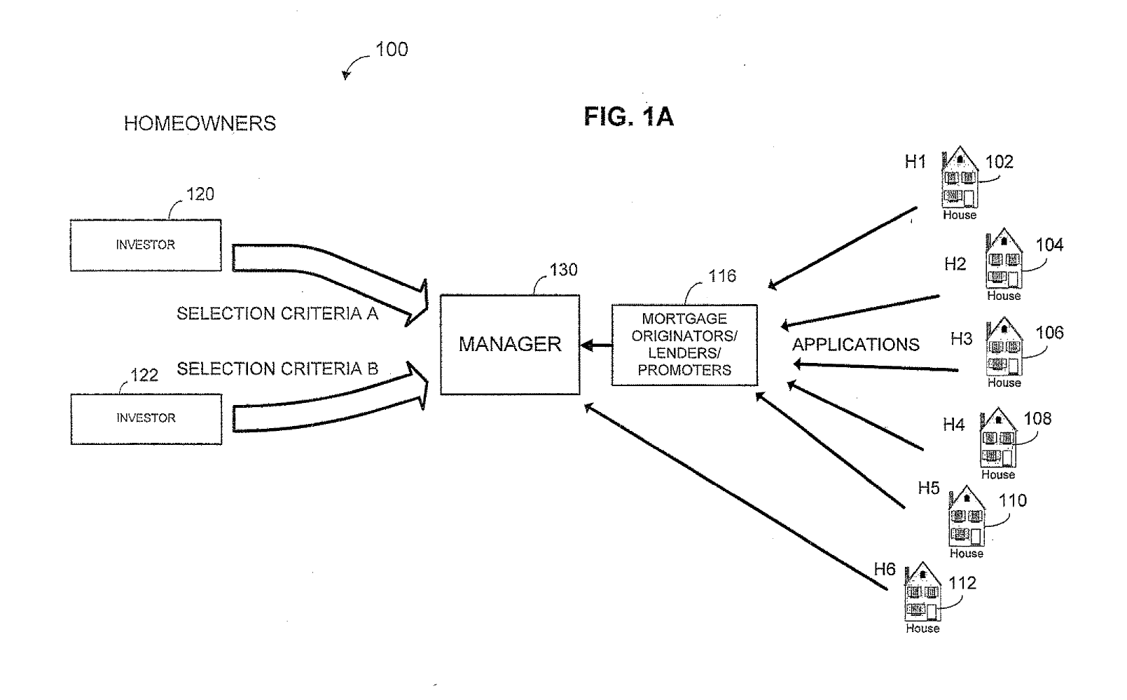

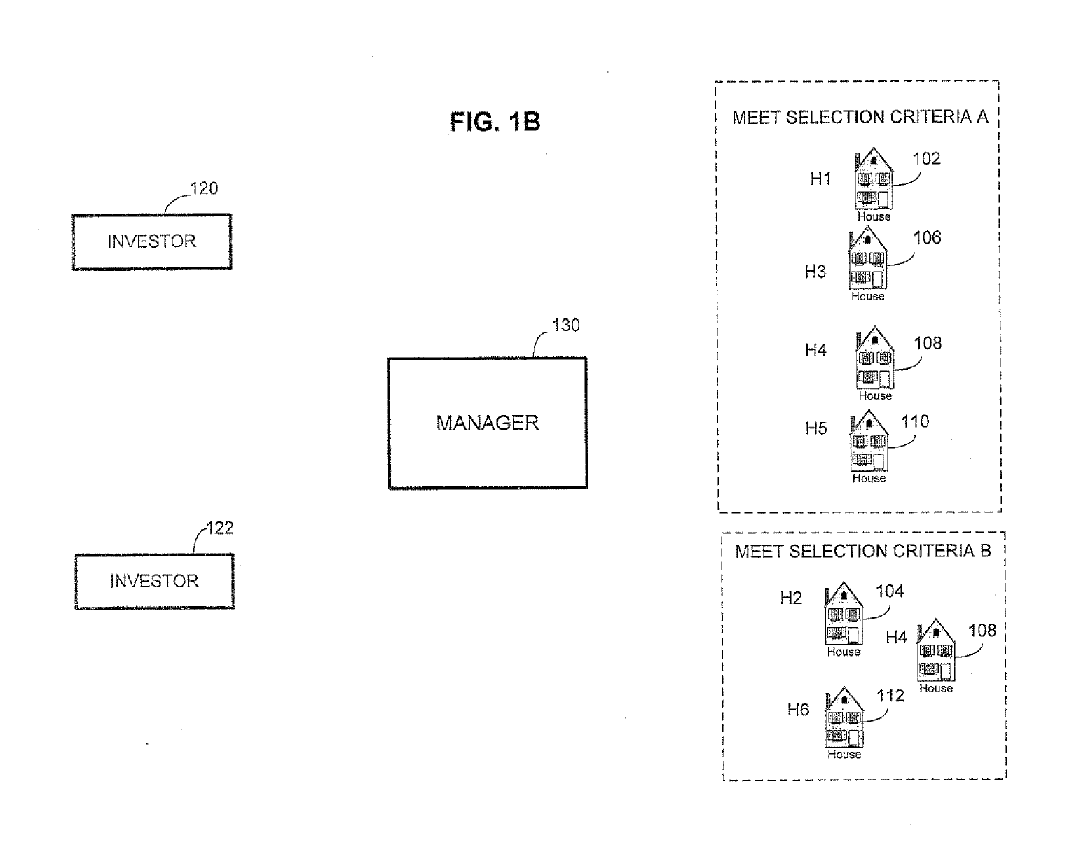

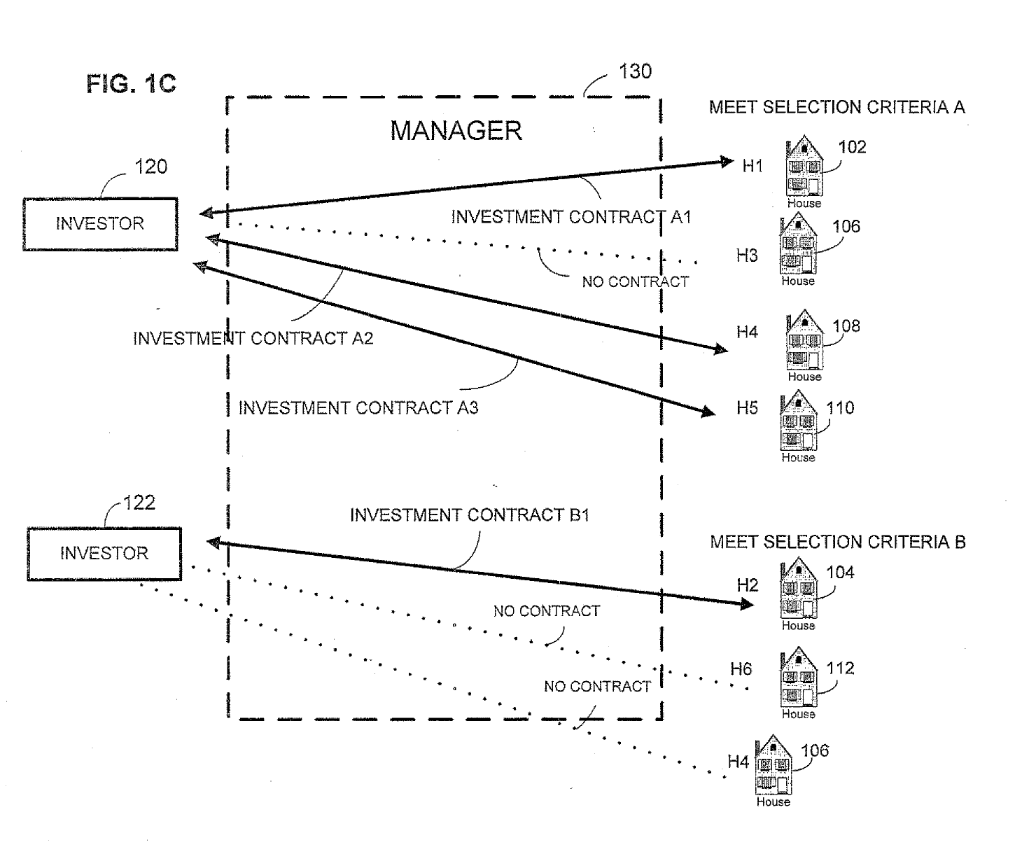

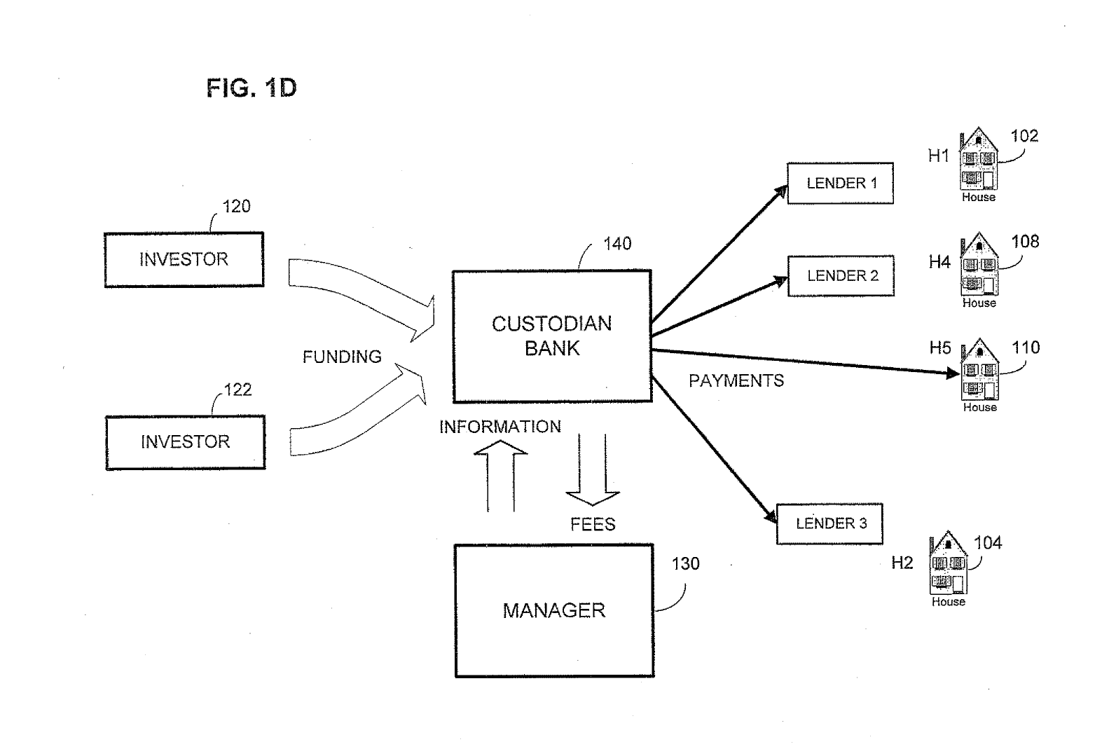

FIG. 1A is a block diagram of a system for enabling investments in real estate assets according to a first embodiment of the present invention. In FIG. 1A the system 100 includes owners of real estate assets 102, 104, 106, 108, 110, 112 who own respective real estate assets H1, H2, H3, H4, H5 and H6. Owners 102, 104, 106, 110 have, or are about to enter into, mortgages with mortgage originators/lenders 116 (hereinafter ‘lenders’), and owners 108 and 112 own their real estate assets free and clear of a mortgage. The lenders 116 constitute the entities that initiate and enter into mortgages with the owners 102, 104, 106, 110 and include mortgage brokers, banks, savings & loans and the like. It is noted that the number of owners (six) and lenders (one) shown is merely for illustrative purposes, and it is anticipated that thousands of owners and hundreds of mortgage originators and lenders will participate in financial arrangements according to the present invention.

Investors 120, 122 may be institutional investors such as state and local pension funds, insurance companies, governmental housing authorities, endowment funds and other public-oriented entities that wish to participate. It is noted that the number of investors (two) shown in FIG. 1A is also merely illustrative, and it is anticipated that numerous investors may participate. In some cases the investors 120, 122 may elect to participate as part of a mandate for social responsibility, to diversify their holdings, and/or simply to achieve a high risk-adjusted return. Investments in residential real estate based assets may be particularly attractive to pension funds, because real estate values correlate much more closely to the liabilities of the funds in terms of providing salary income than do traditional investments in equities and bonds. Investment in residential real estate has historically been less volatile than both equities and bonds as well.

The contract need not require a transfer of real property. As a result, the costs associated with real estate transfers can be avoided and the net proceeds available to the investor and owner are increased.

The owners 102-112, lenders 116 and investors 120, 122 are in contact (by e.g., telephone, email, regular mail) with a manager 130 that preferably performs one or more of the tasks for marketing to owners 102-112 and lenders, attracting investors 120, 122 finding qualifying and suitable real estate assets for investment, facilitating the establishment of contracts between owners and investors and monitoring the contracts post contract formation. The manager 130 may receive fees and a percentage of the payments made by the investors in return for the services it provides. As used herein “manager” is intended to include a single entity or multiple coordinated entities.

Through promotions and marketing efforts to the public, lenders, realtors and relevant non-profit and governmental entities, the manager 130 solicits applications from the owners 102-112 to enter into contracts with the investors to obtain current income in exchange for a share in the potential appreciation of their real estate assets. The manager 130 also receives selection criteria from each of the investors 130 and assembles and, in the depicted embodiment, proposes to an investor each contract that potentially qualifies under the investment criteria. The selection criteria indicate the characteristics of the owners and/or real estate assets in which the investors 120, 122 wish to invest. Investment selection criteria may include, for example, an owner income bracket, a specified geographical region, type of account (first time home owner, senior, etc.), and an expected appreciation rate extrapolated from or based on past statistics and economic forecasts, among other possible criteria.

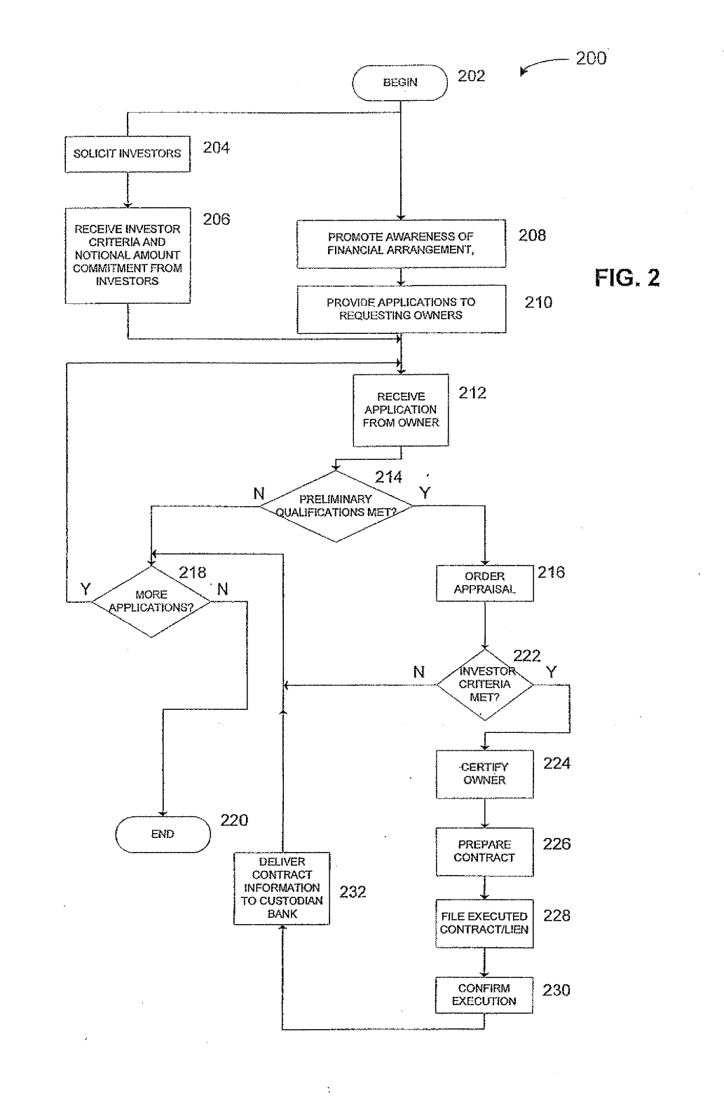

FIG. 2 is a flow chart of a method 200 for establishing a contract between an owner and an investor according to a first embodiment of the present invention. The method begins in step 202. In step 204 the manager 130 solicits investments from institutions and other investors 120, 122. In step 206 the manager receives investment selection criteria and a commitment to invest a notional amount from the investors 120, 122. As described in more detail below the notional amount is the amount on which payments to the owners are based. It typically represents a percentage of the appraised value of the real estate asset at the time of the contract. If, for example, the percentage of the appraised value is 50%, an investor may commit to $10,000,000 in total notional amount and accordingly may provide payments for one hundred (100) owners' homes appraised at $200,000 each (i.e., $20,000,000 in cumulative appraised value which is then divided by 2, resulting in the $10,000,000 contracted notional commitment).

Either prior to, in parallel with, or subsequent to steps 204 and 206, the manager 130, with the assistance of other entities and institutions, promotes awareness to the owners 102-112 of the potential or actual financial opportunity in step 208. More specifically, apart from general advertising through traditional channels or web sites and public relations campaigns, the manager 130 may establish referral programs with lender partners and target affinity groups such as public advocate and credit counseling groups that focus on credit and homeownership. It is expected that local and national lenders will be a substantial and immediate source of referrals, since prospective and current owners typically contact lenders directly for new loans or refinancing. In cases where owners are having difficulty making payments on loans, many lenders may favor the financial arrangement of the present invention, because it provides a superior alternative to the expense and collateral depreciation that comes with foreclosures. Advantageously, lenders are ideally positioned to provide customer-specific data information to the manager. A large number of referrals may also come from community groups, government agencies and training facilities dedicated to supporting affordable housing such as the Neighborhood Reinvestment Corporation, the National Council of State Housing Agencies and The Housing Assistance Counsel.

Owners 102-112 may respond by requesting applications from the manager 130, which are then provided to the owners 102-112 in step 210, to establish an account, i.e., to enter into a contract with an investor. The application materials may require owners 102-112 to seek independent counseling regarding the contract. Proof of such independent counseling may be provided to the manager in the form of a counseling certificate. In step 212 the manager receives a completed application from one of the owners 102-112.

Returning again to the owner/applicant, in step 214, the manager 130 or its approved delegate or agent determines whether the applicant meets preliminary qualifications. The manager 130 may outsource or contract this and other tasks as appropriate. The preliminary qualifications are set by the manager 130 and may require, for example, that: (a) the real estate asset be a residential property housing one-to-four families; (b) title to the asset be free and clear of outstanding liens; (c) the asset be valued (at last appraisal) of less than a threshold amount, or alternatively, more than a threshold amount; and (d) that the applicant not be currently in default on a mortgage. If it is determined in step 214 that an applicant meets the preliminary qualifications, a new appraisal of the applicant's real estate asset is ordered in step 216 to determine the current value of the asset. Otherwise, if it is determined that the applicant does not meet the preliminary qualifications, it is determined in step 218 whether further completed applications are available for review, and if so, the process cycles back to step 206 and another application is reviewed unless there are no further applications, in which case the method ends in step 220.

Assuming preliminary qualifications have been met, after a new appraisal is ordered in step 216, a further review is performed in step 222 to determine whether the applicant and/or the real estate asset in question meets the investor's selection criteria based on the characteristics of the owner and/or the real estate assets. An illustration of the result of this procedure is shown in FIG. 1B. As shown, each investor 120, 122 has a respective Selection Criteria (A) and (B). Review of the characteristics of each owner/asset 102-112/H1-H6 of FIG. 1A indicates that each owner/asset 102/H1, 106/H3, 108/H4 and 110/H5 meets Selection Criteria (A), and each owner/asset 104/H2, 108/H4 and 112/H6 meets Selection Criteria (B). As an example, investor 120 may be a pension fund based in the state of Michigan and may wish to invest only in residential properties in the Detroit metropolitan area appraised at under $500,000 each; each owner/asset 102/H1, 106/H3, 108/H4 and 110/H5 meets these criteria. In contrast, investor 122 may be a fund having a social responsibility mandate that requires: a) assets under $200,000 in value, and b) owners earning under $50,000 in annual income to fulfill their objective to aid owners in difficult financial straits; each owner/asset 104/H2, 108/H4 and 112/H6 meets these criteria. It is noted that owner/asset 108/H4 meets both selection criteria (A) and (B). In this case the contract with owner 108 will be assigned to an investor based on prioritization established by an allocation process, or in the alternative, the notional amount for this owner/asset could be split among investor 120 and investor 122, i.e., each will provide half the payment amount to the owner 108 and will have the right to receive a corresponding portion of the contracted percentage of potential future appreciation of the real estate asset H4 upon termination.

Returning again to FIG. 2, once it is determined that an applicant meets one or more investor selection criteria, the applicant may be ‘certified’ in step 224, by making sure that the applicant has been informed properly about the contract and adequately understands its provisions. This step assures that the homeowner is fully aware of his/her obligations and the potential outcomes.

Once the applicant is certified, the applicant is made aware of the terms offered by the investor for entering into a contract according to the present invention. The main terms are the payment rate, which is typically in the range of 2.5% to 5%, and the percentage of potential appreciation that the investor will receive, which percentage is typically 50% but may go higher. If, for example, the investor and owner agree to a 50% shared appreciation and a 3.5% payment rate and the property is appraised at $250,000, a payment of $364.58 (50% of the home value×3.5%/12) will be made each month to the owner or to the lender. The 3.5% return for sharing future equity may make a dramatic impact on the owners' ability to afford their homes. Applied to a monthly payment at today's thirty-year fixed rate of 6.0%, this may reduce mortgage payments by over 25% on a $225,000 loan (the equivalent of the monthly payment on a 3.3% thirty-year, fixed-rate loan on a $250,000 home value). It is again noted that the payment rate offered by the investor is based on the investor's expected appreciation of the real estate assets. It would be possible, for example, for an investor to provide funds to owners of real estate assets for which the expectation of appreciation is lower than average and yet still to maintain a targeted internal rate of return (IRR) by making lower payments to the owner (lender). The owner of course must agree to accept lower payments in this instance. Alternatively, payments may be set at a higher rate in cases in which the investor expects a higher rate of real estate appreciation. In this manner the investor is able to set and negotiate the terms on which it will agree to enter into (or fund) contracts with the owners. This method is in sharp contrast to the pooling of mortgages, having them rated by a rating agency and packaging them to investors who have had no input into the valuation. In a preferred embodiment the owner will know with whom he or she is contracting and can choose to enter into an agreement on that basis.

Other features may be negotiated in the contract between the owner and the investor. For example, the contract may specify that the applicant/owner cannot sell the real estate asset for a certain length of time (e.g., 2-3 years), allowing a minimum time for appreciation of the assets to occur.

FIG. 1C shows the system of the embodiments of FIGS. 1A and 1B after contracts have been agreed upon between investor 120 and owners 102, 106 and 108 and between investor 122 and owner 110. Although owner/asset 106/H3 qualifies for investment by investor 120, there is no contract because either the investor 120 chose not to enter into a contract with owner 106, or the owner chose not to enter into a contract on the terms that investor 120 set. Similarly, there is no contract between investor 122 and owners 108, 112 despite the fact that both owners/assets 108/H4 and 112/H6 meet the selection criteria of investor 122.

Once the terms of the contract are agreed upon, the manager 130, as shown in FIG. 2, may take the initiative in step 226 to prepare a contract document to be executed by both the investor and owner and signed by a notary. To protect against the owner selling the real estate asset without paying the investor the agreed upon share of any appreciation on the asset that may have occurred, the manager 130 arranges for a copy of the contract between the investor and owner to be filed in the relevant governmental office where property records are kept in step 228 to procure a lien on the property or at least provide a cloud on the title of the property if it is sold without notice to the investor against the terms of the contract. In the case of a purchase or refinancing a title agent may officiate the transaction. In step 230 the manager 130 confirms the execution of the contract and filing of the lien (and any other relevant closing materials) and arranges to maintain records of the confirmed contract (e.g., by opening an account in a database). In step 232 the confirmed contract information is delivered to a custodian bank. After step 232 the method branches to step 218 where it is again determined if there are further applications to review.

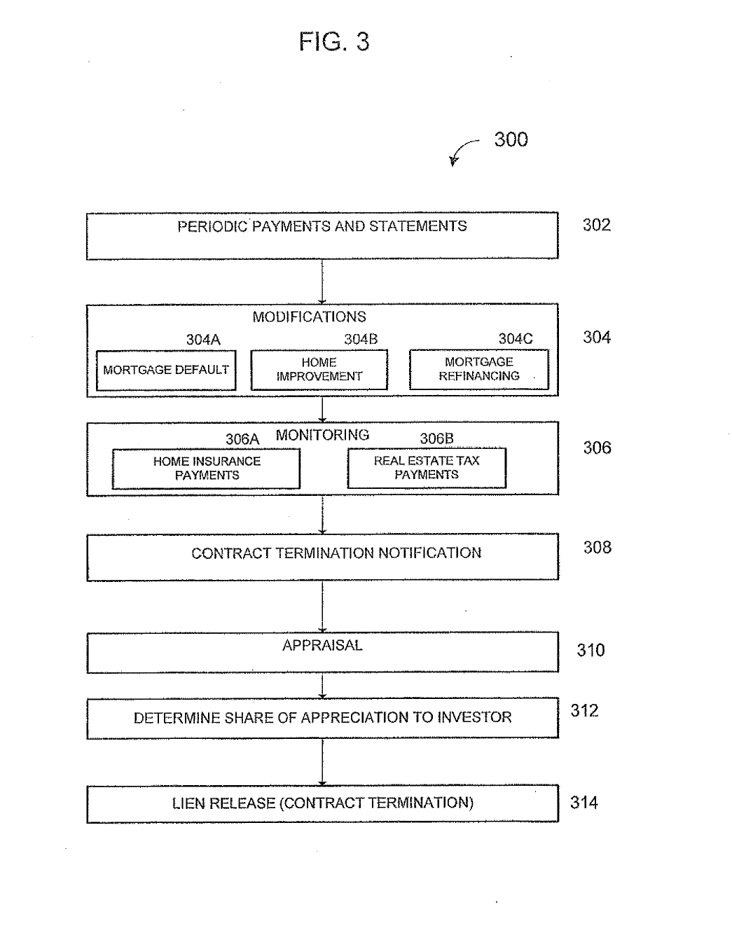

FIG. 3 is a flow diagram of a group of procedures 300 for servicing and maintaining performance of contracts between owners and investors according to an embodiment of the present invention. It is noted that the procedures shown may take place in a somewhat different order than depicted. One of the main tasks of contract servicing performed by the manager 130 is the delivery of periodic payments with accompanying statements (procedure 302) to each owner under the terms of the contract. To simplify this process the investor could deposit instruments in a recognized custodial bank's escrow account (e.g., treasuries or cash equivalents) that are accessible to the manager 130 and can be used by the manager 130 to fund the periodic payments without needing to involve the investor on a short-term periodic basis.

FIG. 1D illustrates payment distribution in the system shown in FIGS. 1A-C. A custodian bank 140 is assigned by the manager 130: (a) to receive funds from the investors 120, 122, and (b) to make scheduled payments to the lenders 1, 2 and 3 who hold the mortgages of owners 102, 104 and 108, and to owner 110. The manager 130 informs the custodian bank 140 as to the timing and the amount of payments and the custodian bank 140 delivers fees associated with the payment events to the manager 130. The manager 130 updates investor information and owner accounts with each payment event.

FIGS. 1A to 1D illustrate an embodiment in which managers find owners and real estate assets that match the selection criteria of the investors and provide information about the matching owners/assets. In this embodiment the investors review this information and then choose to enter into direct contracts with the owners on an individual, one-by-one basis.

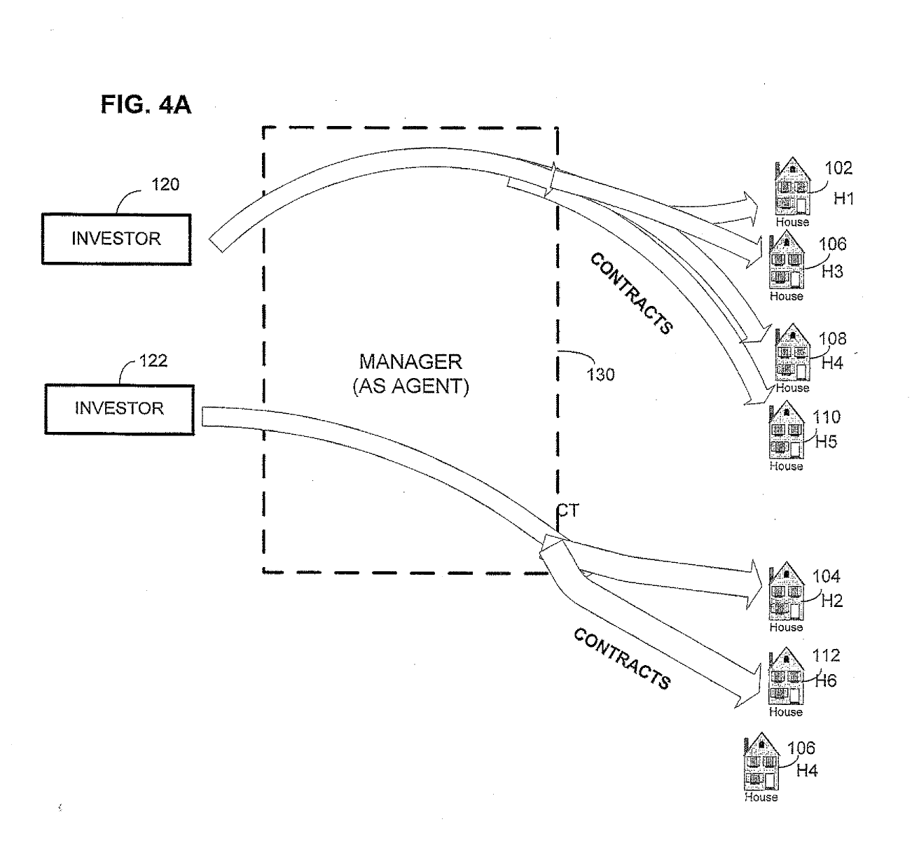

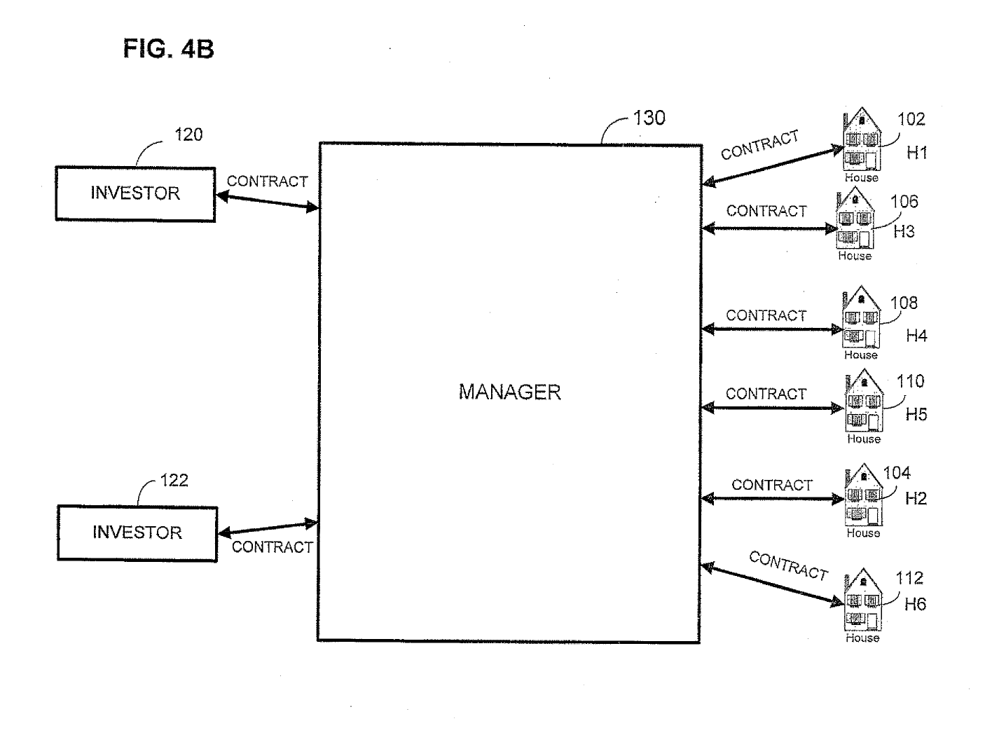

In certain alternative embodiments of the present invention, the investor via its agent enters into contracts directly with the owners. For example, as shown in FIG. 4A, the manager 130 is given authority by the investors 120, 122 to act as the investors' agent in the formation of contracts with the owners 102, 104, 108, 110, 112. More specifically, once the manager finds sets of owners/assets that match each of the investors' criteria, the manager 130 may then enter into contracts with first set of owners 102, 106, 108, 110 on the behalf of investor 120, and may also enter into contracts with a second set of owners 104, 112 on behalf of investor 122, which contracts would be fully binding on the investors 120, 122. Contract formation according to this embodiment is illustrated graphically in FIG. 4A which shows a first set of arrows beginning at investor 120 and extending through the manager 130 to the owners 102, 106, 108, 110, and similarly a second set of arrows beginning at investor 122 and extending through the manager 130 to owners 104, 112. In this embodiment owners/assets that match more than one investor's criteria may be accorded to one of the investors based on prioritization and allocation policies. In the depicted example the manager enters into a contract with owner/asset 106/H3 on behalf of investor 120 and not on behalf of investor 122. Transparency will not be sacrificed in that manager 130 may alert owners 102, 108, 110 and 104, 112 as to the identity of their respective investors (120 and 122).

In another alternative embodiment of the present invention, the investor and owner do not enter contracts with one another, but rather each enters contracts with an intermediary entity, which in the preferred embodiment is the manager. As shown in FIG. 4B, after the manager 130 has determined which owners/assets match Selection Criteria A and Selection Criteria B, the manager 130 enters independently into contracts (stipulating a periodic payment amount and a potential future appreciation percentage) with each of the owners/assets that match any of the selection criteria. In the depicted example the manager 130 would enter into contracts with all of owners/assets 102/H1, 104/H2, 106/H3, 108/H4, 110/H5, 112/H6 based on the investors' stipulations as to payment rates and potential future appreciation rates and other selected criteria (i.e., the manager is not completely free to set the conditions of the contracts with the owners and uses the investor criteria as a guide in negotiations with owners). In this case the manager 130 may explain to the each owners 102-112 that there is a particular investor that will provide funds to make the payments to the owners, but this is not always necessary since the contracts are between the manager 130 and the owners 102-112, and obligations to ensure payments to the owners 102-112 under the contracts fall upon the manager 130.

Before, during or after the manager 130 has established contracts with the owners 102-112, the manager 130 also enters into contracts with the investors 120, 122. The contracts with the investors 120, 122 implement previously agreed-upon stipulations including a notional funding amount, a payment rate, and a potential future appreciation percentage, and the manager may pledge that the owners/assets in which investments are made meet the investors' criteria. The investors 120, 122 may be made aware of the owners/assets that match their criteria; for example, manager 130 may inform investor 120 that its funding will provide payments to owners 102, 106, 108, 110 and that its potential future appreciation is connected to assets H1, H3, H4 and H5, but this is also optional since the representation by the manager 130 that the owners/assets meet the investors' criteria may be sufficient, requiring no further obligation for the manager to provide specific information to the investors as to the owners/assets to the investors.

Returning again to FIG. 3, another task preferably performed is the processing of modifications (procedure 304) that are triggered by certain occurrences (mainly the acts of an owner) during the term of the contract.

Among the occurrences that may trigger modifications are: a) the non-payment of a mortgage payment by an owner (304(A)) which may cause the legal status of the real estate asset to come into question; b) a significant capital improvement to the real estate asset made by an owner (304(B)) that alters the base value upon which appreciation of the real estate asset is to be calculated; c) a request to refinance the real estate asset with a higher mortgage balance (304(C)), and d) other situations which affect the value of the property (e.g., the absence of property maintenance) which affects the financial status of the owner. The manager also monitors (procedure 306) the contracts for timely payments of required home insurance (306(A)) and real estate taxes (306(B)).

Additionally, the manager 130 or a delegate handles contract termination (procedure 308). While depending to some extent on the written terms of the contracts agreed upon by the owners and investors, in general, the contracts terminate when: a) there is an early payoff; b) a mortgage payment default is not corrected within a cure period; c) upon the death of the owner, or d) the real estate asset is sold, and if none of the former apply, e) when a contract term, usually set to 20 years, elapses.

Upon termination of a contract, the manager 130 orders a new appraisal (procedure 310) of the pertinent real estate asset and determines the appreciation, if any, on the real estate asset at the time of termination and the amount of funds to be distributed to the investors (procedure 312). The manager also arranges to release the lien by, for example, filing a document indicating the termination of the contract with the relevant government record office where the contract was originally filed after receipt of the distributed funds has been confirmed (procedure 314).

Statistics suggest that such contracts will typically terminate by a sale, on average seven (7) years after settlement of the contract. Table 1 (below) illustrates a number of examples in which a real estate asset appreciates or depreciates by different amounts (−15%, 0%, 15%, 30% and 45%) over a seven year span, and indicates the overall gains and losses for the owner assuming a 50% shared appreciation percentage with an investor (the gain/loss to the investor is the inverse of the gain/loss to the owner).

TABLE 1

| | Scenario 1 | Scenario 2 | Scenario 3 | Scenario 4 | Scenario 5 |
|---|---|---|---|---|---|
| Original | $250,000 | $250,000 | $250,000 | $250,000 | $250,000 |
| Home Value | | | | | |
| % | −15% | 0% | 15% | 30% | 45% |
| Appreciation | | | | | |
| Sales Price | $212,500 | $250,000 | $287,500 | $325,000 | $362,500 |
| Difference | ($37,500) | $0 | $37,500 | $75,000 | $112,500 |
| Contract | $0 | $0 | $18,750 | $37,500 | $56,250 |
| Settlement | | | | | |
| Annualized | $30,625 | $30,625 | $30,625 | $30,625 | $30,625 |
| Monthly | | | | | |
| Payments | | | | | |
| Contract | $30,625 | $30,625 | $11,875 | (6,875) | ($25,625) |
| Gain/Loss | | | | | |
| (for owner) | | | | | |

As can be seen in Table 1, if the real estate asset is sold with 15% appreciation, there is still a net gain for the owner. It is only when the appreciation reaches about 20% that there is a net loss for the owner and a net gain for the investor.

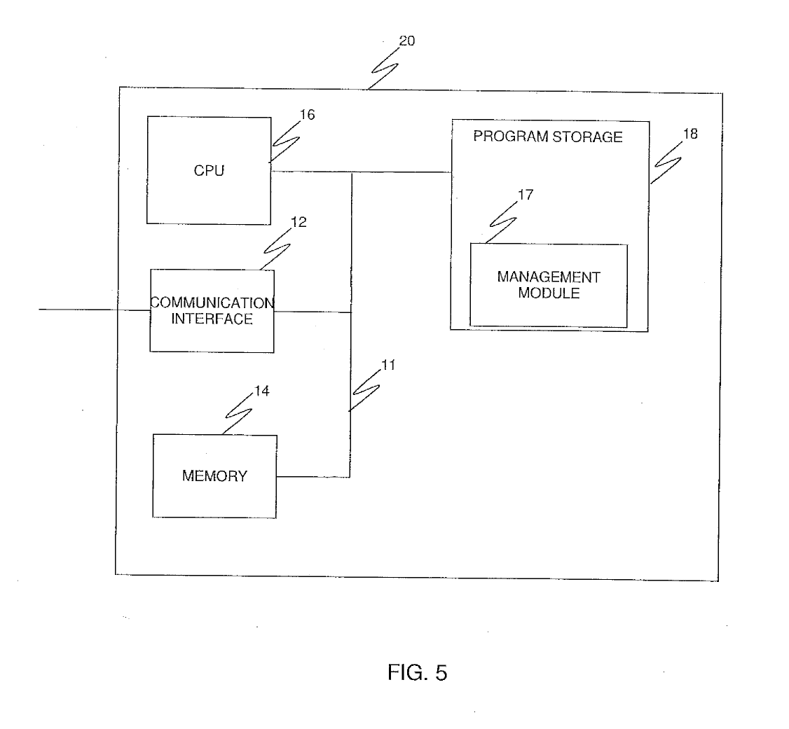

FIG. 5 illustrates a system 20 for enabling investors to invest in potential appreciation of real estate assets of others in exchange for periodic payments to the owners of the real estate assets. The system 20 includes a communication interface 12, a processor (CPU) 16, a memory 14, 18 coupled to the processor, and a management module 17 executable by the processor and adapted to: a) store investor criteria for investments in real estate assets in memory, b) store information pertaining to owners and their real estate assets taken from applications from the owners, c) determine whether the information pertaining to the owners and their real estate assets matches the investor criteria, and d) for those owners where said information matches investor criteria, facilitate establishment of individual contracts with selected owners to exchange periodic payments from the investor for an interest in future appreciation of the corresponding real estate assets of the selected owners by informing the owners and the investors via the communication interface. The elements 12,14,16,18 are all connected to each other through a bus 11.

In one embodiment, the management module stores in the memory a fixed income stream determined by the investor as the periodic payments.

In another embodiment, at least one of the selected owners has a mortgage on the real estate asset for which periodic payments are due to a mortgagee, and the management module 17 stores data regarding the mortgage in the memory 14, 18.

In another embodiment, the management module 17 stores at least one of an expected rate of return, a targeted group of real estate assets and a targeted group of owners of real estate assets as part of the investor criteria.

In another embodiment, the management module 17 stores in the memory 14, 18 an identification of a common association to which a group of owners of real estate assets belong as part of the investor criteria.

In another embodiment, the management module 17 stores in the memory 14, 18 an income level of owners of real estate assets as part of the investor criteria.

In another embodiment, the management module 17 stores in the memory 14, 18 a geographic location of real estate assets as part of the investor criteria.

In another embodiment, the management module 17 stores in the memory 14, 18 a percentage of future appreciation of real estate assets to which the investor has a right.

In another embodiment, the management module 17 stores in the memory 14, 18 periodic payments of a predefined magnitude to be paid by the investor as part of the investor criteria.

In another embodiment, 22 the management module 17 is adapted to determine whether the information in the applications meets preliminary qualifications prior to determining whether the information pertaining to the owners and their real estate assets matches the investor criteria.

In another embodiment, the management module 17 stores in the memory 14, 18 data regarding solvency of the respective owners and title to the respective real estate assets as part of the preliminary qualifications.

In practice of the present invention, owners will have an attractive option to raise needed funds, and investors will find the contract a useful vehicle for obtaining exposure to real estate as an asset class and define its own risk. Through sharing future appreciation without transferring equity, each owner retains ownership in the real estate asset, providing assurance to the investor that the real estate assets will be maintained and retain their value.

The foregoing specific embodiments represent only some of the ways of practicing the present invention. Many other embodiments are possible within the spirit of the invention. Accordingly, the scope of the invention is not limited to the foregoing specification, but instead is given by the appended claims along with their full range of equivalents.

1-23. (canceled)

24. A method of enabling an investor to obtain by contract a right to a defeasible contingent interest in the future appreciation in a real estate asset he does not own, in exchange for such investor making periodic payments to the owner or the mortgagee of selected ones of said real estate assets, comprising:
a. obtaining from said investor ‘investor criteria’ for which he is willing to invest in said real estate assets;
b, obtaining applications from a plurality of owners of real estate assets each of whom agrees to exchange an interest in the potential future appreciation of his respective real estate asset for periodic payments from said investor, each of said applications including ‘owner information’ pertaining to the respective owner and to his real estate asset;
c. storing said ‘investor criteria’ and said ‘owner information’ in a computer system;
d. determining by using said computer system which of said applications includes ‘owner information’ that matches the ‘investor criteria’ of said investor; and
e. for each of said applications having ‘owner information’ that matches ‘investor criteria’ of said investor, providing and facilitating for execution a contract for said respective investor and owner, for said investor to make periodic payments to said owner or to his mortgagee in exchange for an interest in said potential future appreciation of the corresponding real estate asset of said owner.

25. A method of enabling a plurality of investors each to obtain by contract a right to a defeasible contingent interest in the future potential appreciation in a real estate asset owned by owners who are other than said investor, in exchange for such investors making periodic payments to said owners or the mortgagees of selected ones of said real estate assets, comprising:
a. obtaining from each of said investors ‘investor criteria’ for which he is willing to invest in said real estate assets;
b. obtaining applications from a plurality of owners of real estate assets each of whom agrees to exchange an interest in the potential future appreciation of his respective real estate asset for periodic payments from one of said investors, each of said applications including ‘owner information’ pertaining to the respective owner and to his real estate asset;
c. storing said ‘investor criteria’ and said ‘owner information’ in a computer system;
d. determining by using said computer system which of said applications includes ‘owner information’ that matches the ‘investor criteria’ of one of said investors; and
e. for each of said applications having ‘owner information’ that matches ‘investor criteria’ of one of said investor, providing and facilitating for execution a contract for said respective investor and owner, for said investor to make periodic payments to said owner or to his mortgagee in exchange for an interest in said potential future appreciation of the corresponding real estate asset of said owner.

26. The method of claim 25 wherein said periodic payments comprise a fixed income stream determined by the investor.

27. The method of claim 25 wherein at least one of said selected owners has a mortgage on said real estate asset for which periodic payments are due to a mortgagee, and said periodic payments by said investor are submitted to the mortgagee for said at least one selected owner.

28. The method of claim 25, wherein said investor criteria includes at least one of an expected rate of return, a targeted group of real estate assets and a targeted group of owners of real estate assets.

29. The method of claim 28, wherein said investor criteria targets a group of owners of real estate assets according to a common association to which they belong.

30. The method of claim 28, wherein the investor criteria targets a group of owners of real estate assets according to their income level.

31. The method of claim 28, wherein the investor criteria targets a group of real estate assets according to a geographic location of the real estate assets.

32. The method of claim 25, wherein the investor interest in potential future appreciation of real estate assets comprises a right to a percentage of future appreciation.

33. The method of claim 25, wherein the investor criteria includes periodic payments of a predefined magnitude to be paid by the investor for his interest in said real estate asset.

34. The method of claim 25, further comprising, prior to determining whether the information in the applications matches the investor criteria, establishing preliminary qualifications for said applications and reviewing said applications to determine whether the information in the applications meets said preliminary qualifications.

35. The method of claim 34, wherein the preliminary qualifications includes solvency of the respective owners and unencumbered title to the respective real estate assets.

36. A system for enabling investors to obtain by contract a right of a defeasible contingent interest in the future potential appreciation of real estate assets owned by owners who are other than said investors in exchange for periodic payments to said owners or mortgagees respectively of said real estate assets, comprising:
a. a communication interface that receives from said investors their criteria ‘investor criteria’ for investments in said real estate assets, and receives from said owners their applications with information pertaining to each owner and to his respective real estate asset ‘owner information’ for which he agrees to exchange an interest in potential future appreciation of the corresponding real estate asset in exchange for receipt of periodic payments from such investor;
b. a processor,
c. a memory coupled to the processor, and
d. a management module stored in the memory and executable by the processor, the management module adapted:
i. to store said received ‘investor criteria’ in the memory,
ii. to store in the said received memory information pertaining to said owners and their real estate assets taken from applications from said owners,
iii. determine which of said ‘owner information’ matches the ‘investor criteria’, and
iv. for those owners where said ‘owner information’ matches ‘investor criteria’, providing and facilitating for execution a contract for each of said respective investors and owners, where said investor agrees to make periodic payments to the owner or his mortgagee, in exchange for an interest in the potential future appreciation of the corresponding real estate assets of the selected owner by informing the owners and the investors via the communication interface.

37. The system of claim 36 wherein the management module stores in the memory a fixed income stream determined by the investor as said periodic payments.

38. The system of claim 36 wherein:
at least one of said selected owners has a mortgage on said real estate asset for which periodic payments are due to a mortgagee; and
the management module stores data regarding said mortgage in the memory.

39. The system of claim 36, wherein the management module stores at least one of an expected rate of return, a targeted group of real estate assets and a targeted group of owners of real estate assets as part of said investor criteria.

40. The system of claim 39, wherein the management module stores in the memory an identification of a common association to which a group of owners of real estate assets belong as part of said investor criteria.

41. The system of claim 39, wherein the management module stores in the memory an income level of owners of real estate assets as part of said investor criteria.

42. The system of claim 39, wherein the management module stores in the memory a geographic location of real estate assets as part of said investor criteria.

43. The system of claim 36, wherein the management module stores in the memory a percentage of future appreciation of real estate assets to which the investor has a right.

44. The system of claim 36, wherein the management module stores in the memory periodic payments of a predefined magnitude to be paid by the investor as part of said investor criteria.

45. The system of claim 36, wherein the management module is adapted to determine whether the information in the applications meets preliminary qualifications prior to determining whether the information pertaining to the owners and their real estate assets matches the investor criteria.

46. The system of claim 45, wherein the management module stores in the memory data regarding solvency of the respective owners and title to the respective real estate assets as part of said preliminary qualifications.
